(19) United States
(12) Patent Application Publication
(10) Pub. No.: US 2025/0123600 A1
(43) Pub. Date: Apr. 17, 2025

(54) Methods, Computing Nodes and System for Controlling a Physical Entity

(71) Applicant: Telefonaktiebolaget LM Ericsson (publ), Stockholm (SE)

(72) Inventors: János Harmatos, Budapest (HU); Gábor Németh, Budapest (HU); Péter Mátray, Budapest (HU)

(21) Appl. No.: 18/730,402

(22) PCT Filed: Mar. 18, 2022
(86) PCT No.: PCT/EP2022/057118

§ 371 Date: Jul. 19, 2024

(51) Int. Cl. G05B 9/03; G05B 19/042

(52) U.S. Cl. CPC G05B 9/03; G05B 19/0421; G05B 2219/24186; G05B 2219/24187

(57) ABSTRACT

Methods and Nodes for Controlling a Physical Entity A method (100) is disclosed for controlling a physical entity. The method is performed by a controller node running at least two instances of a logical control function. The method comprises receiving over an input mechanism node input data relating to the physical entity (110) and providing, to each of the at least two instances of the control function, instance input data generated from the node input data. The method further comprises causing at least one of the instances to process the received instance input data and generate instance output data, and providing, over an output mechanism, instance output data from at least one of the instances of the control function, wherein the output mechanism is operably connected to the physical entity. The method further comprising synchronizing an internal state of each of the at least two instances of the control function.

### TECHNICAL FIELD

The present disclosure relates to computer implemented methods for controlling a physical entity. The methods are performed by a controller node, and by a system comprising a plurality of controller nodes. The present disclosure also relates to a controller node, a system, and to a computer program product configured, when run on a computer, to carry out methods for controlling a physical entity.

### BACKGROUND

The present disclosure relates to control of a physical entity, for example in an industrial machine control scenario such as control of factory robots. In many such industrial control scenarios, both calculation and transmission of control information is performed in a cloud infrastructure, and control elements may include both network and compute redundancy for ultra-low latency reliability i.e., working in a proactive failure handling regime. Typically, the actuator of the entity being controlled is capable of communicating only with a single controller application instance. Reliability is a crucial aspect of such industrial control applications, in order to ensure that operations are both safe and efficient.

One natural approach for reliability and resiliency for industrial cloud control use cases is to use a traditional monolithic controller application but deploy it in the cloud infrastructure with redundancy (i.e., multiple instances of the controller). This ensures that if a failure occurs in the cloud domain, there will be at least one working controller instance that can still serve the device, providing seamless, continuous communication. Applications that follow this pattern include replicated controllers that execute periodic loops, e.g., continuous monitoring and control of servo motors or other moving mechanical parts, or safety detection and progress monitoring. Application instances may additionally externalize their critical internal state, comprising some data representing a model of a part of the physical reality, into an external distributed database. The distributed database may replicate the stored states to multiple locations. In this manner, whenever a failure occurs in the cloud domain (i.e., an application instance, or VM, or node), another (potentially newly started) instance can read back the copy of the lost states and continue operations.

However, in an industrial control scenario, if physical devices are controlled from replicated monolithic controller instances in the cloud domain, it can quickly become very challenging to manage state transitions during a failure event in the cloud. This is because the internal states of the controller instances can diverge with time. As a consequence of this divergence of internal states, failing over from one controller instance to another may cause inconsistencies in the cyber-physical system, potentially causing efficiency, or even safety violations.

For example, it may be envisaged that a controller instance of a mobile robot decides to avoid an obstacle (like another robot, or a human) by moving around the obstacle to the left, while the replica controller instance would decide to move around the obstacle to the right. If a cloud failure happens during the bypass maneuver, the mobile robot may receive inconsistent control messages, causing an emergency stoppage, or even a collision. In addition, simply duplicating a monolithic control application in the cloud still results in monoliths that otherwise do not benefit from all the advantages of the cloud, like the ability to independently develop and deploy services, and to scale them with a fine granularity. Due to these reasons, it might be more costly to develop and operate monolithic applications in a resilient manner.

As industrial cloud control applications evolve, they are starting to exploit the flexibility benefits of cloud infrastructure by following a more cloud like, or cloud-native design. Cloud-native design involves decomposing a monolithic controller application into multiple smaller functional modules, so called microservices, which communicate with each other. This architectural style can address some of the issues mentioned above, greatly increasing development speed, deployment flexibility and elasticity. There are well-known methods for achieving reliability, availability, and resiliency for such microservice-like application in generic cloud systems. The widely used approach is to deploy multiple instances of the application components (microservices), and distribute those instances onto different locations (Virtual Machines, nodes, datacenters).

The above process for micro-service based cloud control works well for many entirely digitally based control applications (provision of web services, etc.). However, when a typical microservice (or cloud function) is scaled out to achieve reliability or to manage load, the instances of the same function are loosely coupled, with minimal cross-communication between them. This is intentional and good for traditional cloud applications, like web applications, but for industrial control functions it comes with the same challenge as described above: in the face of an instance failure, other instances of the same function may be out-of-sync to the failed one, potentially causing harm in the cyber-physical world.

### SUMMARY

It is an aim of the present disclosure to provide methods, a controller node, a system and a computer program product which at least partially address one or more of the challenges mentioned above. It is a further aim of the present disclosure to provide methods, a controller node, a system and a computer program product which cooperate to provide reliability for industrial cloud control systems, including microservice-style control applications, according to which switching between application instances during failures would not cause uncertainty in physical device control.

According to a first aspect of the present disclosure, there is provided a computer implemented method for controlling a physical entity, wherein the method is performed by a controller node running at least two instances of a logical control function. The method comprises receiving, over an input mechanism, node input data relating to the physical entity, and providing, to each of the at least two instances of the control function, instance input data generated from the node input data. The method further comprises causing at least one of the instances to process the received instance input data and generate instance output data, and providing, over an output mechanism, instance output data from at least one of the instances of the control function, wherein the output mechanism is operably connected to the physical entity. The method further comprising synchronizing an internal state of each of the at least two instances of the control function.

According to another aspect of the present disclosure, there is provided a computer implemented method for controlling a physical entity in accordance with a control application, wherein the method is performed by a system comprising a plurality of controller nodes, each controller node implementing a logical control function comprised within the control application. The method comprises receiving, over an input mechanism and at an input controller node of the system, system input data relating to the physical entity, and causing the system input data to be sequentially processed by the logical control functions of individual controller nodes in the system to generate system output data. The method further comprises providing the system output data over an output mechanism, wherein the output mechanism is operably connected to the physical entity. According to the method, at least one of the plurality of controller nodes in the system performs a method according to the first aspect of the present disclosure.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more of the aspects or examples of the present disclosure.

According to another aspect of the present disclosure, there is provided a controller node for controlling a physical entity, wherein the controller node is operable to run at least two instances of a logical control function. The controller node comprises processing circuitry configured to cause the controller node to receive, over an input mechanism, node input data relating to the physical entity, and provide, to each of the at least two instances of the control function, instance input data generated from the node input data. The processing circuitry is further configured to cause at least one of the instances to process the received instance input data and generate instance output data, and to provide, over an output mechanism, instance output data from at least one of the instances of the control function, wherein the output mechanism is operably connected to the physical entity. The processing circuitry is further configured to cause the controller node to synchronize an internal state of each of the at least two instances of the control function.

According to another aspect of the present disclosure, there is provided a controller node for controlling a physical entity, wherein the controller node is operable to run at least two instances of a logical control function. The controller node is configured to receive, over an input mechanism, node input data relating to the physical entity, and to provide, to each of the at least two instances of the control function, instance input data generated from the node input data. The controller node is further configured to cause at least one of the instances to process the received instance input data and generate instance output data, and to provide, over an output mechanism, instance output data from at least one of the instances of the control function, wherein the output mechanism is operably connected to the physical entity. The controller node is further configured to synchronize an internal state of each of the at least two instances of the control function.

According to another aspect of the present disclosure, there is provided a system for controlling a physical entity in accordance with a control application, the system comprising a plurality of controller nodes, each controller node implementing a logical control function comprised within the control application. The system is configured to receive, over an input mechanism and at an input controller node of the system, system input data relating to the physical entity, and to cause the system input data to be sequentially processed by the logical control functions of individual controller nodes in the system to generate system output data. The system is further configured to provide the system output data over an output mechanism, wherein the output mechanism is operably connected to the physical entity. At least one of the plurality of controller nodes in the system comprises a controller node according to any one or more of the aspects or examples of the present disclosure.

Aspects of the present disclosure thus provide methods and nodes that facilitate reliability of industrial control applications in cloud execution environments, including for example factory machine and robot control. Examples of the present disclosure enable switching control between replicated cloud function instances without introducing inconsistency in the device control itself, owing to the synchronization of individual control function instances. Failover events would consequently have a far more limited impact on the control application's safety and efficiency characteristics. Examples of the present disclosure propose a two-regime synchronization mechanism between function instances, allowing for adaptation to different latency requirements. Examples of the present disclosure can be employed to implement monolithic controller applications, or to replace the monolithic software development approach with a set of componentized versions of their logically disjoint functions. Each control function can be scaled independently of the others, while maintaining the reliability properties of the solution proposed herein.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a computer implemented method for controlling a physical entity;

FIGS. 2a to 2c show flow charts illustrating another example of a method for controlling a physical entity;

FIG. 3 is a flow chart illustrating process steps in another computer implemented method for controlling a physical entity;

FIG. 4 is a flow chart illustrating another example of a method for controlling a physical entity;

FIG. 5 is a block diagram illustrating functional modules in an example controller node;

FIG. 6; is a block diagram illustrating functional modules in another example controller node;

FIG. 7 is a block diagram illustrating functional modules in an example system of controller nodes;

FIG. 8 illustrates a more detailed overview of a system of controller nodes;

FIG. 9 illustrates in greater detail a single element of the system illustrated in FIG. 8;

FIG. 10 is a flow chart illustrating an example implementation of the method of FIGS. 2a to 2c; and

FIG. 11 illustrates different states in which a controller node can exist.

### DETAILED DESCRIPTION

As discussed above, examples of the present disclosure provide methods that enable reliable failover between instances of a control application, or logical function of such an application, in an industrial control setting involving control of a physical entity. The reliability ensures that the physical entity is provided with consistent control instructions even when failover between control instances is carried out.

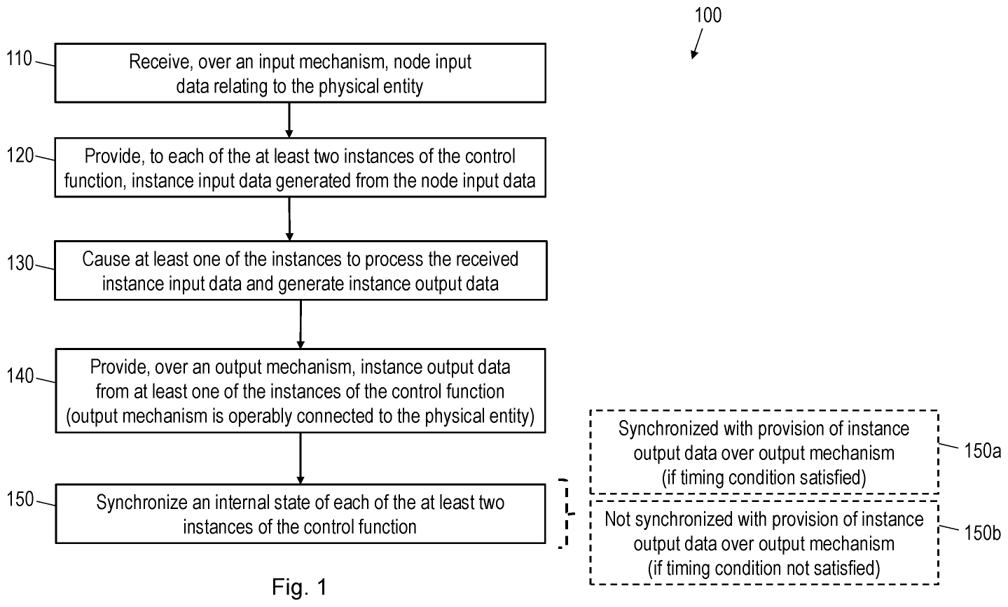

FIG. 1 is a flow chart illustrating process steps in a computer implemented method 100 for controlling a physical entity, wherein the method is performed by a controller node running at least two instances of a logical control function. The controller node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. The controller node may encompass multiple logical entities, as discussed in greater detail below, and may for example comprise a Virtualised Network Function (VNF).

Referring to FIG. 1, the method 100 comprises, in a first step 110, receiving, over an input mechanism, node input data relating to the physical entity. The method then comprises, in step 120, providing, to each of the at least two instances of the control function, instance input data generated from the node input data. In step 130, the method comprises causing at least one of the instances to process the received instance input data and generate instance output data. The method then comprises, in step 140, providing, over an output mechanism, instance output data from at least one of the instances of the control function, wherein the output mechanism is operably connected to the physical entity. The method also comprises, in step 150, synchronizing an internal state of each of the at least two instances of the control function. It will be appreciated that while the flow chart of FIG. 1 illustrates the step 150 of synchronizing an internal state of the instances of the control function as being carried out after the step 140 of providing output data, this is merely for the purposes of illustration. As will be discussed in greater detail below, the step 150 of synchronizing internal states may be carried out before, after, or concurrently with the provision of output data in step 140.

As discussed above, the synchronization of internal states of the individual instances of the control function after receipt of each item of input data (this synchronization taking place before, during or after provision of output data), allows for fast failover in an industrial control setting involving control of a physical entity without compromising control of the physical entity. By ensuring that no conflict exists between states of different instances of the function, seamless transfer from one instance to another is ensured in the event of failure of an instance.

According to examples of the present disclosure, the physical entity may comprise an apparatus such as a robot or machine, an item of equipment, an environment etc. Examples of physical entities include industrial machines, robots, controlled environments for industrial processes such as reaction chambers, manufacturing and assembly equipment, etc. The logical control function may comprise an entire control application (monolithic controller), or may comprise a single logical function of such an application, such as a microservice. The input data may comprise control information stating how the entity is to be controlled, and/or may comprise data reflecting a physical situation or condition of the entity, and/or it may comprise output data from a preceding controller node in a service chain (as discussed in greater detail below). In some examples, the input data may comprise a combination of physical data from the entity (for example in a feedback loop involving the physical entity and the controller node) and control information and/or output from a preceding node in a chain.

The input and output mechanisms may comprise a database, message queues, a communication channel, etc. The operable connection between the output mechanism and the physical entity may be via one or more additional controller nodes, or may be via one or more actuators operable to carry out or effect the control determined by the controller node on the physical entity. Such actuators may be a part of the physical entity (for example movement actuators for a robot), or may be separate to the entity (for example actuators controlling environmental conditions or reagent concentrations within a reaction chamber).

The flow chart of FIG. 1 illustrates two possible synchronization modes for the step 150, which may in some examples be incorporated into the method 100. In a first example, as illustrated at 150a, the may method comprise synchronizing internal states of the at least two instances of the control function in a process that is itself synchronized with the providing, over the output mechanism, of instance output data from at least one of the instances of the control function. This “synchronous” synchronization mode may be employed if a combined instance processing and instance state synchronization time satisfies an operational timing condition. In another example, as illustrated at 150b, the method may comprise synchronizing internal states of the at least two instances of the control function in a process that is not synchronized with provision, over the output mechanism, of instance output data from at least one of the instances of the control function. This “asynchronous” synchronization mode may be employed if a combined instance processing and instance state synchronization time does not satisfy an operational timing condition.

For the purposes of the present disclosure, the combined instance processing and instance state synchronization time may comprise a time taken for all instances of the control function to process an instance input data and generate instance output data, and for all instances of the control function to complete synchronization of their internal states. The process of synchronizing internal states across instances of the control function may be accomplished in any appropriate manner, including for example distributed consensus algorithms such as Raft (https://raft.github.io/raft.pdf), or Paxos (https://doi.org/10.1145/279227.279229). It will be appreciated that the manner in which state synchronization is accomplished may remain the same regardless of its timing, i.e., regardless of whether the process of synchronizing internal states is itself synchronized or not with the provision of output from the node. Synchronization may be triggered by any of the instances.

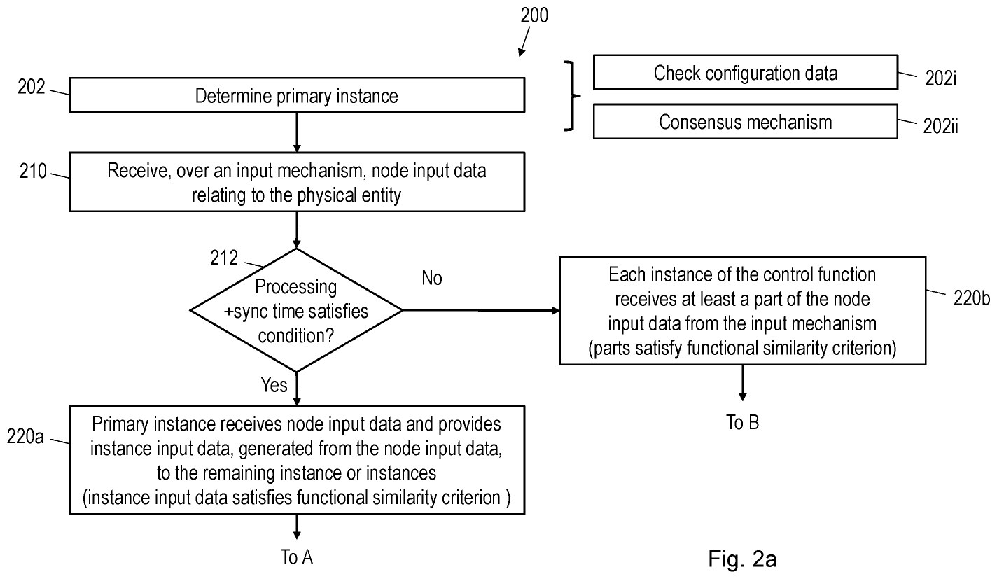

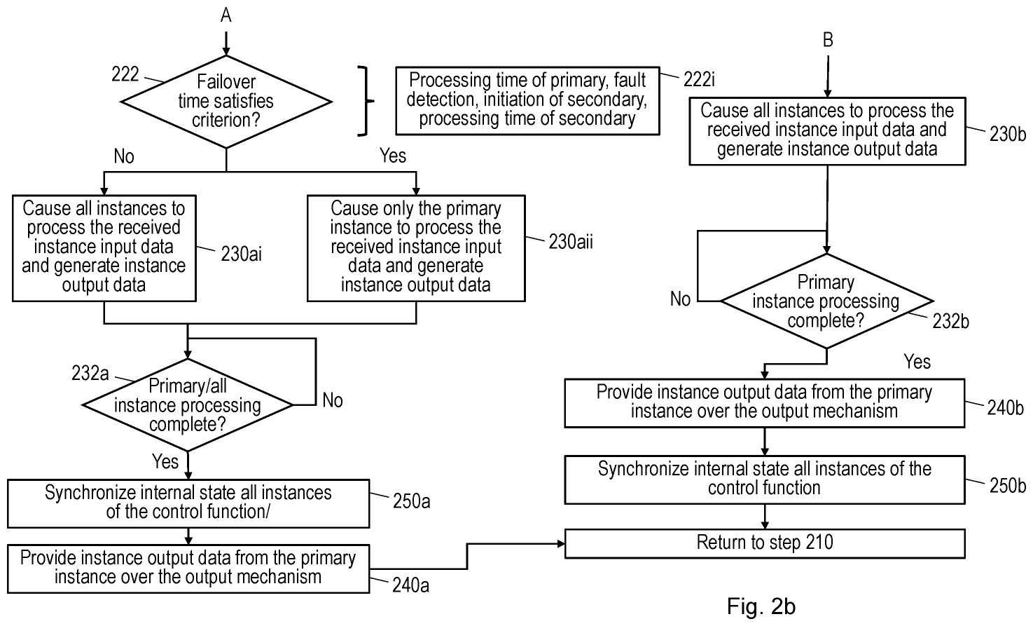

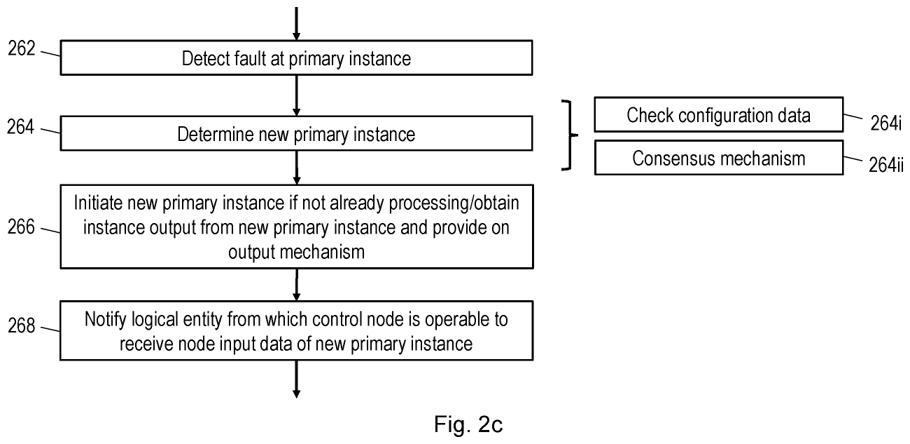

FIGS. 2a to 2c show flow charts illustrating another example of a method 200 for controlling a physical entity. As for the method 100 discussed above, the method 200 is performed by a controller node running at least two instances of a logical control function. The controller node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. The controller node may encompass multiple logical entities, as discussed in greater detail below, and may for example comprise a Virtualised Network Function (VNF). The method 200 illustrates examples of how the steps of the method 100 may be implemented and/or supplemented to provide the above discussed and additional functionality.

Referring initially to FIG. 2a, in a first step 202, the controller node may determine which of the at least two instances of the control function comprises a primary instance, with the remaining instances being secondary instances. The step 202 of determining a primary instance from among the instances of the logical control function running on the controller node may in some examples comprise checking configuration data identifying the primary instance in step 202i or using a consensus mechanism to determine the primary instance in step 202ii. The consensus mechanism may take several forms, including for example simply selecting the fastest of the instances, or of those instances that were previously considered to be secondary instances, to be the primary instance. In the case of configuration data, a hierarchy of secondary instances may be configured to dictate an order in which secondary instances may become primary instances in the event of failure or fault. This is discussed in further detail below with reference to FIG. 2c.

In step 210, the controller node receives, over an input mechanism, node input data relating to the physical entity. This node input data may in some examples be received only at the primary instance of the control function, with the primary instance then distributing instance input data, based on the node input data, to the secondary instances, or the node input data may be received at all instances of the control function. These different options for the receipt of node input data are discussed in greater detail below.

In step 212, the controller node determines whether a combined instance processing and instance state synchronization time satisfies a timing condition, wherein the timing condition is based upon a timing parameter of a control loop of which the control function is a part. As discussed above, for the purposes of the present disclosure, the combined instance processing and instance state synchronization time may comprise a time taken for all instances of the control function to process an instance input data and generate instance output data, and for all instances of the control function to complete synchronization of their internal states. The timing condition may for example correspond to the duration of a feedback or control loop of which the control function is a part. Step 212 may thus comprise determining whether or not there is time between receipt of consecutive node input data for all instances of the control function to process an instance input data, generated from the node input data, and generate instance output data, and for all instances of the control function to complete synchronization of their internal states. This determination may be performed for example by checking hard coded settings or measuring times for processing, state synchronization and control loop feedback.

The result of step 212 determines whether the controller node will go on to operate in the “asynchronous” or “synchronous” synchronization modes discussed above, also referred to as fast loop and slow loop functioning. If the timing condition is satisfied, this means that there is sufficient time to operate in the synchronous synchronization mode (slow loop), and the controller node will proceed to execute steps 220a to 240a, as illustrated in FIGS. 2a and 2b. If the timing condition is not satisfied, this means that there is insufficient time to operate in the synchronous synchronization mode, for example owing to strict latency requirements on a control loop of which the control function is a part, and so the controller node operate is asynchronous synchronization mode (fast loop), executing steps 220b to 250b, as illustrated in FIGS. 2a and 2b. It will be appreciated that in some instances, the controller node may commence operations in one mode and then switch if the determination at step 212 indicates that this is appropriate. For example, on a first iteration of the method 200, the processing and synchronization time, and timing condition, may not yet be accurately known, and so the controller node may start in synchronous synchronization mode (slow loop) and then switch to asynchronous mode (fats loop) if the processing and synchronization time is too long compared to the length of time for execution of a single control loop.

The right hand section of FIGS. 2a and 2b illustrates the case in which the controller node determines at step 212 that the combined instance processing and instance state synchronization time does not satisfy a timing condition. In this case (No at step 212), the step of providing, to each of the at least two instances of the control function, instance input data generated from the node input data comprises, at step 220b, each of the at least one instances of the control function receiving at least a part of the node input data from the input mechanism. As illustrated at 220b, in some examples, the instance input data provided to any one instance of the control function satisfies a functional similarity criterion with respect to the instance input data provided to all other instances of the control function. The precise nature of the functional similarity criterion may be determined with respect to the information content of the input data and the processing of the instances of the control function. The purpose of the functional similarity criterion is to ensure that a difference between instance input data provided to two different instances is not sufficient to produce a difference in instance output data that exceeds an acceptability threshold. The functional similarity criterion may thus be established based on an acceptability threshold determined by an operator or administrator, and the variation within the particular input data for a given controller node that can be accommodated without causing a difference in output that exceeds that acceptability threshold. It will be appreciated that the precise value and nature of the functional similarity criterion will therefore vary according to the particular use case and deployment scenario of the controller node. In some examples, each instance of the control function may receive adjacent frames of a video feed, or adjacent sensor measurement values in a time series of such values.

Referring now to FIG. 2b, the controller node then, in step 230b, causes all instances to process the received instance input data and generate instance output data. In step 232b, the controller node determines whether the processing of the primary instance is complete, and as soon as that is the case, the controller node provides over an output mechanism that is operably connected to the physical entity, instance output data from the primary instance. The output mechanism may be a database, a message queue, a communication channel, etc. The operable connection between the output mechanism and the physical entity may involve one or more intermediate entities. For example, the controller node may output data to one or more further controller nodes that is/are implementing one or more different control functions, or may output data directly to the physical entity, or to equipment or apparatus controlling the physical entity.

In step 250b, the controller node synchronizes an internal state of each of the at least two instances of the control function. It will be appreciated that, under this asynchronous mode of synchronization of internal instance states, the controller node provides, over the output mechanism, instance output data from the primary instance of the control function as soon as such instance output data is generated, and without waiting for synchronization of the internal states of the primary and secondary instances. The primary instance may in some examples trigger the synchronization of instance internal states at step 250b after provision of the instance output data. As discussed above, the process of synchronizing internal states of the primary and secondary instances may be carried out using any suitable state synchronization process.

Referring again to FIG. 2a, the left hand section of FIGS. 2a and 2b illustrates the case in which the controller node determines at step 212 that the combined instance processing and instance state synchronization time does satisfy a timing condition. In this case, the step of providing, to each of the at least two instances of the control function, instance input data generated from the node input data comprises, at step 220a, one of the instances receiving the node input data and providing instance input data, generated from the node input data, to the remaining instance or instances. As illustrated at step 220a, the instance receiving the node input data may comprise the primary instance.

Generating the instance input data from the node input data may comprise providing a copy of the node input data, or providing at least a part of the node input data to each instance. As discussed above with reference to the asynchronous synchronization mode, in some examples, the instance input data provided to any one instance of the control function satisfies a functional similarity criterion with respect to the instance input data provided to all other instances of the control function. The functional similarity criterion may be determined with respect to the information content of the data and the processing of the instances of the control function, such that a difference between instance input data provided to two different instances is not sufficient to produce a difference in instance output data that exceeds an acceptability threshold.

Referring again to FIG. 2b, the controller node then, in step 222, checks whether a failover time for the controller node satisfies a failover timing condition. As illustrated at 222i, the failover time comprises a time taken for processing of instance input data by the primary instance, detection of a fault at the primary instance, initiation of a secondary instance, and processing of instance input data by the initiated secondary instance. If the failover time satisfies the failover timing condition, then there is sufficient time to detect a primary instance fault, initialize a secondary instance, and process instance input data at the secondary instance before an output is required from the controller node, or before a new input is received at the controller node, or before some other temporal requirement for correct operation of the control function. The failover timing condition may then be set according to the specific timing requirements for the physical entity and the control loop of which the controller node is a part.

The controller node then causes at least one of the instances to process the received instance input data and generate instance output data. If the failover time satisfies the failover timing condition, the controller node causes only the primary instance to process the received instance input data and generate instance output data, as illustrated at step 230aii. This can save on energy and computing resource by avoiding parallel processing by all instances, and is acceptable as the check at step 222 has determined that there will be sufficient time to generate an output using one of the secondary instances should the primary instance fail.

If the failover time does not satisfy the failover timing condition, the controller node causes all instances to process the received instance input data and generate instance output data at step 230ai.

It will be appreciated that the check at step 222 regarding the failover timing condition may be omitted if the controller node is operating in asynchronous synchronization mode, as described above. This is based on the understanding that if the combined processing and synchronization time does not satisfy the operational timing condition, then the controller node is already operating under highly stringent latency requirements, and thus parallel processing by all instances is appropriate.

Referring still to FIG. 2b, in step 232a, the controller node checks whether the instance processing is complete. If the controller node has caused all instances to process the received instance input data then the controller node checks at step 232a that all instances have completed their processing of the instance input data. If the controller node has caused only the primary instance to process the received instance input data then the controller node checks, at set 232a, that the primary node has completed its processing of the instance input data. Once the primary or all instances have completed processing of the instance input data, the controller node then synchronizes an internal state of each of the at least two instances of the control function in step 250a. As discussed above, this synchronization of internal states may be achieved in any suitable manner, and may in some examples be initiated by the primary instance. In step 240a, the controller node provides, over an output mechanism, instance output data from at least one of the instances of the control function, wherein the output mechanism is operably connected to the physical entity. The instance from which output data is provided is in some examples the primary instance. As illustrated in FIG. 2b, synchronizing an internal state of each of the instances of the control function takes place after completion of processing of instance input data by each instance of the control function (or by the primary instance if the failover time condition is satisfied) and before providing, over the output mechanism, instance output data from at least one of the instances of the control function. It will be appreciated that in this manner, the synchronizing of the internal states of the instances of the control function is synchronized with provision, over the output mechanism, of instance output data from at least one of the instances of the control function.

As discussed above, the output mechanism may be operably connected to the physical entity via one or more additional controller nodes, or via other equipment such as actuators, or may be directly connected to the physical entity.

Following completion of the step 240a of provision of output data, in the case of synchronous synchronization mode, or completion of step 250b of synchronization, in the case of asynchronous synchronization mode, the controller node then returns to step 210 of the method 200, receiving new node input data and performing a new iteration of the method steps.

FIG. 2c illustrates steps that may be carried out as part of the method 200. The steps illustrated in FIG. 2c may be performed by the controller node at any time during the execution of the steps illustrated in FIGS. 2a and 2b, triggered by detection of a fault in an instance of the logical control function, as discussed in further detail below.

Referring now to FIG. 2c, at step 262, the controller node detects a fault at a primary instance of the control function. This primary instance has been previously determined according to the steps discussed above. On detecting a fault at the primary instance in step 262, the controller node is triggered to determine, in step 264, which of the remaining instances of the control function should now become the primary instance. As illustrated at steps 264i and 264ii, the controller node may make the determination of step 264 by either checking configuration data identifying the primary instance in step 264i, and/or using a consensus mechanism to determine the primary instance in step 264ii. The consensus mechanism may take several forms, including for example simply selecting the fastest of the secondary instances to be the primary instance. In the case of configuration data, a hierarchy of secondary instances may be configured to dictate an order in which secondary instances may become primary instances in the event of failure or fault.

Having determined the new primary instance, the controller node may initiate the new primary instance, if the new primary instance is not already running, and/or may obtain instance output from the new primary instance and provide that output over the output mechanism at step 266. The precise actions to be performed at step 266 may depend on whether the controller node was operating in synchronous or asynchronous synchronization mode at the time that the fault was detected, and whether all instances or only the primary instance were processing instance input data. The purpose of step 266 is to ensure that output data is provided on the output mechanism from a functioning primary instance before the next node input data is received at the controller node. In step 268, the controller node may notify a logical entity from which the control node is operable to receive node input data, informing the entity of which of the at least two instances of the control function is now the primary instance. The logical entity may for example be a preceding node in a function chain, as discussed below.

As mentioned above, individual controller nodes performing examples of the methods 100, 200 may be chained together to form a system. In such examples, a single control application may be divided into individual logical control functions, with each control function being implemented by a different controller node performing examples of the methods 100, 200. In this manner, each controller node may receive input data from either or both of the physical entity to be controlled and a preceding controller node in the chain. Each controller node may additionally [provide output directly to the physical entity and/or to a succeeding controller node in the chain. In some examples the chain of controller nodes may be organised such that an input controller node operates at a level of abstraction of the control operation, receiving for example a control instruction for the physical entity, and this control instruction may be processed at gradually decreasing levels of abstraction from the physical entity by the chain of controller nodes and their logical control functions, until an output node provides output control instruction directly to the physical entity, which output instructions are at the level of abstraction of the physical entity, enabling the physical entity to enact the control instruction received at the input controller node.

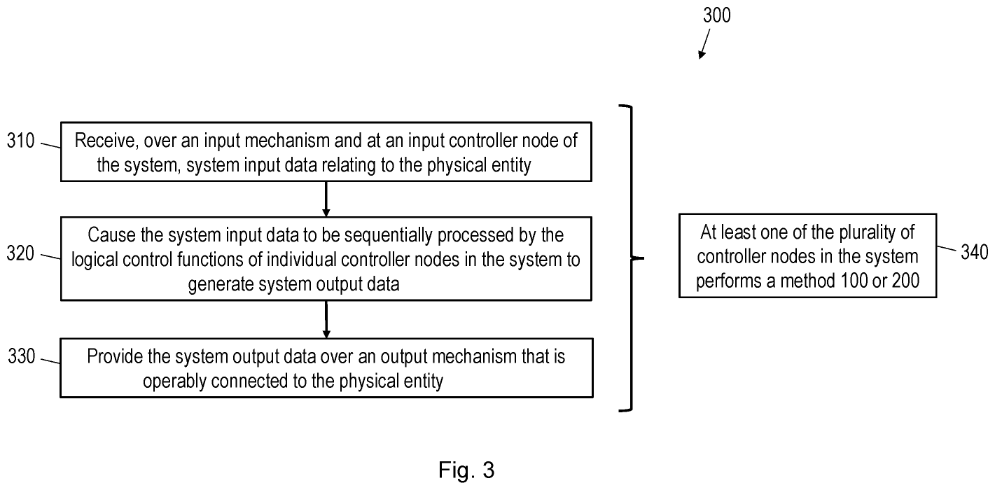

FIG. 3 is a flow chart illustrating process steps in a computer implemented method 300 for controlling a physical entity in accordance with a control application. The method is performed by a system comprising a plurality of controller nodes, each controller node implementing a logical control function comprised within the control application. Each controller node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. Each controller node may encompass multiple logical entities, as discussed in greater detail below, and may for example comprise a Virtualised Network Function (VNF).

Referring to FIG. 3, the method 300 comprises, in step 310, receiving, over an input mechanism and at an input controller node of the system, system input data relating to the physical entity. The method 300 further comprises causing the system input data to be sequentially processed by the logical control functions of individual controller nodes in the system to generate system output data in step 320. In step 330, the method 300 comprises providing the system output data over an output mechanism, wherein the output mechanism is operably connected to the physical entity. As illustrated at step 340, at least one of the plurality of controller node in the system performs a method according to any one of the examples of the method 100 and/or 200 described above.

According to examples of the method 300, a plurality of nodes forming a system are orchestrated to sequentially process system input data in order to implement a control application as a series of individual logical functions such as microservices. It will be appreciated that the method 300 requires that “at least one” of the nodes in the system is operating according to examples of the method 100 and/or 200. This does not exclude the possibility that several or indeed all of the nodes in the system are operating according to these methods, but it may be the case that one or more of the nodes in the system is running only a single functional instance of its particular control function, and consequently does not operate according to the method 100 and/or 200.

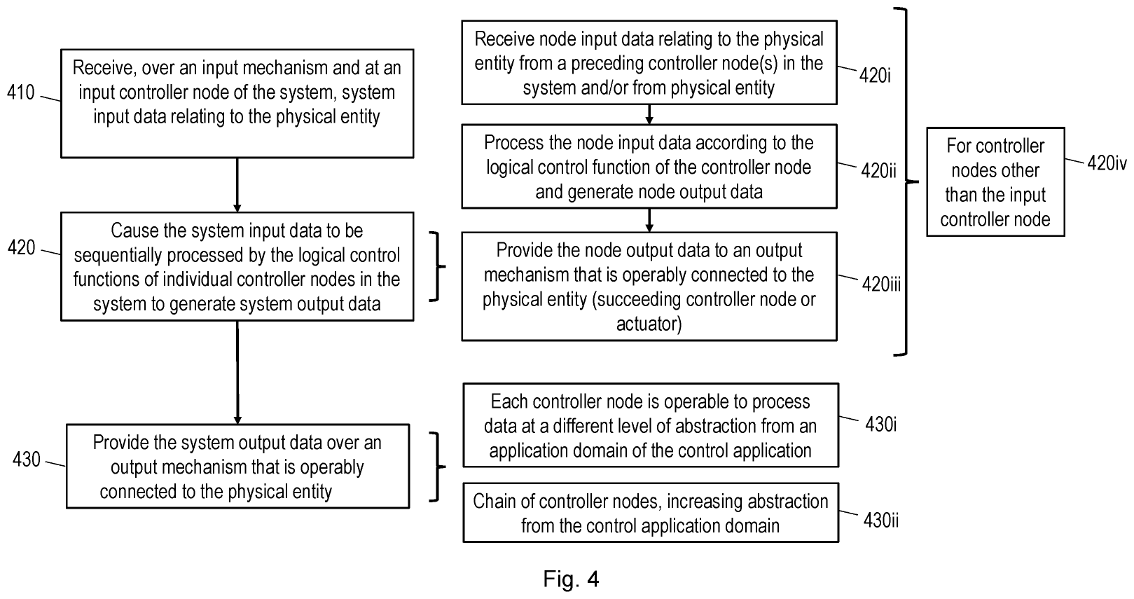

FIG. 4 is a flow chart illustrating another example of a method 400 for controlling a physical entity in accordance with a control application. As for the method 300 discussed above, the method 400 is performed by a system comprising a plurality of controller nodes, each controller node implementing a logical control function comprised within the control application. Each controller node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. Each controller node may encompass multiple logical entities, as discussed in greater detail below, and may for example comprise a Virtualised Network Function (VNF). At least one of the plurality of controller nodes in the system performs a method according examples of the methods 100 and/or 200 described above. The method 400 illustrates examples of how the steps of the method 300 may be implemented and/or supplemented to provide the above discussed and additional functionality.

Referring to FIG. 4, the system initially receives, in step 410, system input data relating to the physical entity over an input mechanism and at an input controller node of the system. In step 420, the system then causes the system input data to be sequentially processed by the logical control functions of individual controller nodes in the system to generate system output data. Performing step 420 may comprise, as illustrated in FIG. 4, carrying out steps 420i to 420iii for controller nodes other than the input controller node, as illustrated at step 420iv. In step 420i, individual controller nodes other than the input controller node receive, over an input mechanism and from a preceding controller node in the system, node input data relating to the physical entity. It will be appreciated that while in one example, controller nodes in the system may be organized in a single chain, such that each controller node receives node input data from a preceding node in the chain, and provides node output data to a succeeding node in the chain, in other examples it may be that each controller node in the system is operable to receive node input data from a plurality of other controller nodes in the system, and is operable to provide node output data to a plurality of other controller nodes in the system. Each controller node in the system may also be operable to receive node input data from the physical entity, for example in a closed feedback loop.

In step 420ii, the controller nodes then process the node input data according to the logical control function of the controller node, and generate node output data before, in step 420iii, providing the node output data to an output mechanism that is operably connected to the physical entity. As discussed above, the operable connection to the physical entity may be via one or more succeeding controller nodes in the chain, or one or more other controller nodes in the system, or may be via one or more actuators or other equipment or apparatus. Such actuators may be operable to carry out the control determined by the controller node on the physical entity, for example by virtue of being a part of the physical entity (such as movement actuators on a robot) or by virtue of acting on the physical entity in some other manner (such as actuators controlling environmental or chemical conditions within a reaction chamber, etc.). A controller node with an output mechanism connected to an actuator may comprise an output controller node for the system.

It will be appreciated that the step 420ii of processing node input data may comprise one or more of the controller nodes of the system performing steps according to examples of the methods 100, 200 described above.

Referring still to FIG. 4, having generated the system output data in step 420, the system then, in step 430, provides the system output data over an output mechanism, wherein the output mechanism is operably connected to the physical entity. Step 430 may thus be carried out by the action of a final output controller node providing the node output over an output mechanism to the physical entity, as discussed above. In this manner the node output of the final or output controller node may become the system output.

As discussed above, each controller node of the system may be operable to process data at a different level of abstraction from an application domain of the control application. For example, if the controller nodes of the system comprise a chain from an input controller node to an output controller node, the input controller node may be operable to process data from an application domain of the control application, and each controller node in the chain may be operable to process data at an increasing level of abstraction from the application domain, with the output controller node operable to provide output data that is consistent with the physical domain of the physical entity.

As discussed above, the methods 100 and 200 may be performed by a controller node, and the present disclosure provides a controller node that is adapted to perform any or all of the steps of the above discussed methods. The controller node may comprise a physical node such as a computing device, server etc., or may comprise a virtual node. A virtual node may comprise any logical entity, such as a Virtualized Network Function (VNF) which may itself be running in a cloud, edge cloud or fog deployment. The controller node may be operable to be instantiated in a cloud based deployment. In some examples, the controller node may be instantiated in a physical or virtual server in a centralised or cloud based deployment.

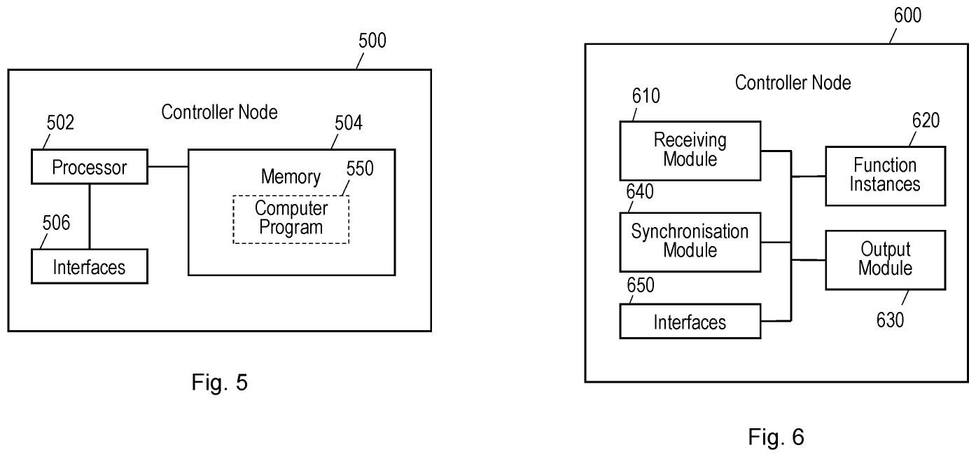

FIG. 5 is a block diagram illustrating an example controller node/module 500 which may implement the method 100 and/or 200, as illustrated in FIGS. 1 and 2a to 2c, according to examples of the present disclosure, for example on receipt of suitable instructions from a computer program 550. Referring to FIG. 5 the controller node 500 comprises a processor or processing circuitry 502, and may comprise a memory 504 and interfaces 506. The processing circuitry 502 is operable to perform some or all of the steps of the method 100 and/or 200 as discussed above with reference to FIGS. 1 and 2a to 2c. The memory 504 may contain instructions executable by the processing circuitry 502 such that the controller node 500 is operable to perform some or all of the steps of the method 100 and/or 200, as illustrated in FIGS. 1 and 2a to 2c. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive, etc.

FIG. 6 illustrates functional modules in another example of controller node/module 600 which may execute examples of the methods 100 and/or 200 of the present disclosure, for example according to computer readable instructions received from a computer program. It will be understood that the modules illustrated in FIG. 6 are functional modules, and may be realized in any appropriate combination of hardware and/or software. The modules may comprise one or more processors and may be integrated to any degree.

Referring to FIG. 6, the controller node 600 is for controlling a physical entity, and is operable to run at least two instances of a logical control function. The controller node/module TT600 comprises a receiving module 610 for receiving, over an input mechanism, node input data relating to the physical entity and for providing, to each of the at least two instances of the control function, instance input data generated from the node input data. The controller node further comprises function instances 620, and is operable to cause at least one of the instances to process the received instance input data and generate instance output data. The controller node further comprises an output module 630 for providing, over an output mechanism, instance output data from at least one of the instances of the control function, wherein the output mechanism is operably connected to the physical entity. The controller node further comprises a synchronization module 640 for synchronizing an internal state of each of the at least two instances of the control function. The controller node 600 may further comprise interfaces 650, which may be operable to facilitate communication with an output mechanism and with other nodes or modules, over suitable communication channels.

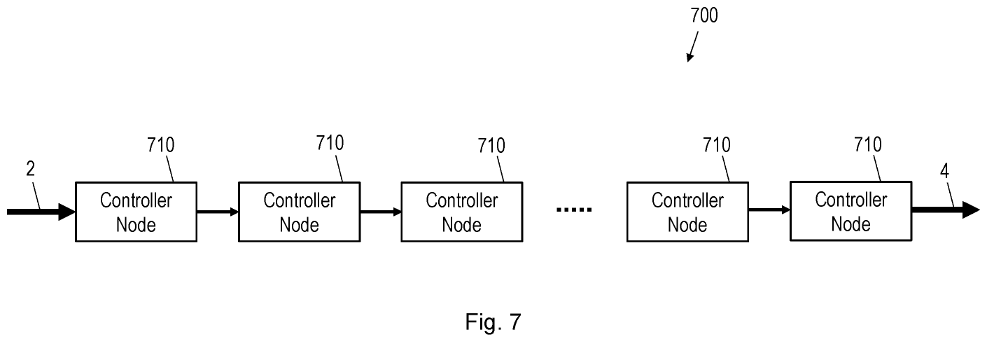

As discussed above, the methods 300 and 400 are performed by a system for controlling a physical entity in accordance with a control application, and the present disclosure provides a system that is adapted to perform any or all of the steps of the above discussed methods. FIG. 7 illustrates such a system 700 which comprises a plurality of controller nodes 710, each controller node implementing a logical control function comprised within the control application. The system is configured to receive, over an input mechanism 2 and at an input controller node of the system, system input data relating to the physical entity, and to cause the system input data to be sequentially processed by the logical control functions of individual controller nodes in the system to generate system output data. The system is further configured to provide the system output data over an output mechanism 4, wherein the output mechanism is operably connected to the physical entity. At least one of the plurality of controller nodes 710 in the system comprises a controller node 500 or 600.

FIGS. 1 to 4 discussed above provide an overview of methods which may be performed according to different examples of the present disclosure. These methods may be performed by controller node and a system of controller nodes respectively, as illustrated in FIGS. 5 to 7. The methods enable reliable failover between instances of a control application, or logical function of such an application, in an industrial control setting involving control of a physical entity, ensuring that the physical entity is provided with consistent control instructions even when failover between control instances is carried out. There now follows a detailed discussion of how different process steps illustrated in FIGS. 1 to 4 and discussed above may be implemented. The functionality and implementation detail described below is discussed with reference to the controller nodes and system of FIGS. 5 to 7 performing examples of the methods 100, 200, 300 and/or 400, substantially as described above.

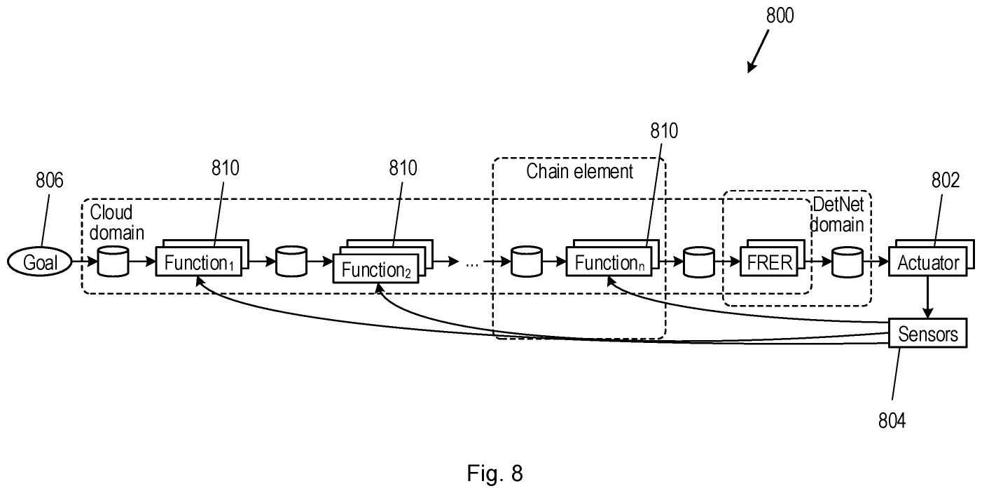

FIG. 8 illustrates a more detailed overview of a system 800 of controller nodes 810 implementing control functions of a control application. The control application is orchestrating control of a physical entity, with control effected by one or more actuators 802 that act upon the entity, and the physical state of the entity represented by information from sensors 804. A goal 806 is input to the system 800, which goal is expressed at the level of abstraction of the control application. This goal is then successively processed through the individual controller nodes 810, which each node receiving an input from the preceding node, and feeding an output to the succeeding node. Individual controller nodes 810 may also receive input directly from the physical entity being controlled, via the output of sensors 804. Each controller node 810, together with its corresponding input/output mechanism(s) represents one link in the chain of control functions that is formed by the system 800. In the illustrated example, the controller nodes are essentially instantiated in the cloud.

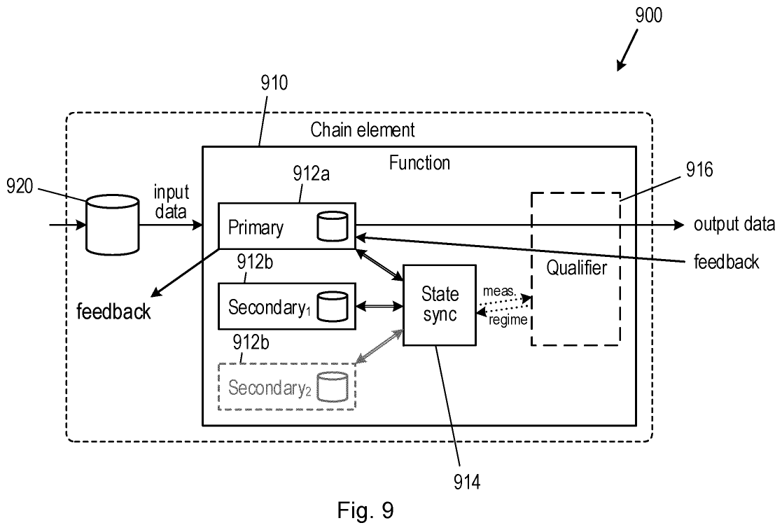

FIG. 9 illustrates in greater detail a single chain element 900, comprising a controller node 910 implementing a control function, and an input/output mechanism 920. The controller node 910 comprises one or more instances 912 of the control function, each instance operable to act on similar instance input. It will be appreciated that, as discussed above, the instance input may not be identical for all instances but, depending on implementation, may rather be an eventually consistent representation coming from the preceding chain element. An example is video stream-based object recognition, in which adjacent image frames may contain substantially the same information, and consequently separate function instances may be capable of identifying the same object without being in possession of all of the image frames provided to the controller node, or indeed in possession of identical image frames. One solution for example could be a round robin allocation of incoming image frames, so that a first frame is provided to a first function instance, a second frame to a second function instance, and then the third frame is provided to the first function instance again. In this manner, the capacity of the instances to perform object recognition, and to recognize the same objects, is not hindered, despite not acting upon identical instance inputs.

The controller node further comprises a State Synchronization mechanism 914, through which the function instances 912 synchronize their internal state substantially continuously. The State synchronization mechanism 914 may in some examples be in-built in each instance, or may be implemented as a separate module such as a database. This synchronization may also be referred to as representation synchronization, as the internal state corresponds to the instances' representation of the state of the block. It will be appreciated that the substantially continuous synchronization encompasses the possibility that instances to differ in their internal state on a time scale that is below the natural time range of their operations: i.e., states can differ in two instances for a time that is shorter than the time needed to execute the logic of the controller node.

The instances 912 of the controller node include at all times a primary instance 912a, which is the leader and is exclusively allowed to send output (thus ensuring elimination of duplicate outputs. The remaining stances of the function are secondary instances 912b. The controller 910 also comprises a Qualifier module 916 that is responsible for automatically determining whether the controller node should operate in synchronous or asynchronous synchronization mode. The determination of the Qualifier module is communicated to the function instances 912 and their synchronization module.

Controller nodes, also referred to as function blocks, or simply blocks, receive input from, and may produce output towards other blocks. In general, blocks that a given block receives from are referred to as preceding block(s), and block(s) that the given block sends to are referred to as succeeding blocks. This relationship is strictly local to the block, that is the architecture does not restrict a block to only have one of either: in general, a block may have any number of preceding and following blocks, including zero.

Each controller node or block in the chain of the system may be envisaged as a step (or function) of the overall control application, with each function executing a possibly increasingly low latency/more time constrained task in multiple replicas at each step. The only exceptions are the first step, which sets the overall goal of the control, like “move a specific type of robot there”, and the last step, which represents the physical reality of the entity (for example the robots).

It will be appreciated that several closed control loops may exist between the actuator(s) executing control on the physical entity and the different controller nodes with different latency requirements. Depending on the task that is solved by a function the latency requirements may vary.

### Fast and Slow Loop Regimes

Fast loop regime involves all secondary instances belonging to a certain controller node being active and executing their task in parallel to produce output. This regime ensures that if the primary (leader) instance fails then the output of any secondary instance can be used immediately for the input of the controller node to be provided to the next node in the chain. If for example, the controller node is the part of a control loop with strict timing requirement, this regime may be made mandatory.

If the time budget allowed for the operation of a certain controller node allows, then the secondary instances can be operated in a so-called warm hot-standby mode. In this case, the secondary instances receive the input of the controller node, but in normal operation mode they do not execute their task, only state synchronization is performed to the primary instance. If the primary instance fails, then the secondary instances are activated and start to execute their task to produce the output of the controller node. This operation mode requires lower computation resources than the case when each secondary instance is active, but in the case of a failure the switchover is longer.

If closed control loop exists, a controller node can also obtain input for its operation from a certain type of sensor belonging to the system, e.g., installed on an actuator device or mounted one or near the physical entity. In order to ensure consistent operation, the synchronization between the function instances of a certain block should be performed within the operation time of the closed loop where the functions are involved.

Synchronization between the function instances that belong to a given controller node can be initiated by the primary function instance (which sent the control data to the following function). Alternatively, if an instance detects that another one has already sent the control data, it can initiate state synchronization. From feedback received from the succeeding controller node or from the physical entity, discrepancies can be detected, and state synchronization can be performed

### Controller Node Operation

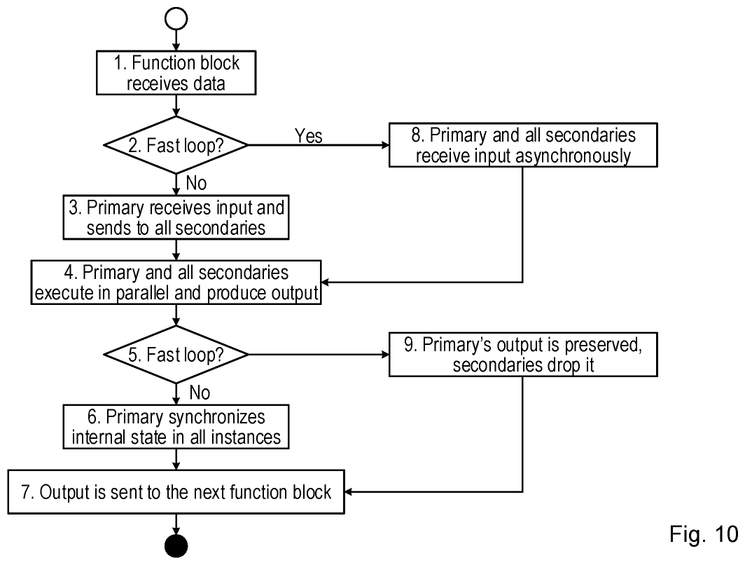

FIG. 10 is a flow chart illustrating an example implementation of the method 200. In the implementation of FIG. 10, the controller node is referred to as a function block, and is part of a chain of function blocks in a system. Block operation is divided into three consecutively executed phases, any or all of which may be absent for a specific block implementation:
1. Receiving input from preceding block(s)
2. Processing input & producing output
3. Sending output to succeeding block(s)

A significant property of block operation is the time budget allowed for the given block by the control loop of which it is a part. Either the block executes fast enough for a full input and output synchronization to be carried out (its processing time in phase 2 above is lower than some implementation-specific threshold), or the synchronization takes too much time and the output should be provided faster than the synchronization can be finished. The former situation is referred to as slow loop, and allows for synchronous synchronization of instance states. The latter situation is referred to as fast loop regime, and does not allow for synchronous synchronization of instance states. The logic of the three phases above may differ for the two regimes, as discussed below.

### Phase 1: Receiving Input (Method Steps 110, 120, 210, 212, 220a, 220b)

Logically, a function block or controller node is receiving input from its preceding block(s) and may also be receiving input from external sensors. Receipt of this input may be implemented differently for the slow and fast loops, as show in FIG. 10:
Slow loop (step 3 of FIG. 10 and 220a of FIG. 2a): input data is received by the primary function instance, and distributed to the secondaries, asserting that all get substantially the same data for processing. This might be accomplished via a consensus protocol, or simple proxying copies of the data.
Fast loop (step 8 of FIG. 10, and 220b of FIG. 2a): input data is received by all instances, primary and secondaries in parallel. In an implementation, this may be done by using a publish/subscribe type of messaging, for example.

### Phase 2: Processing (Method Steps 130, 230ai, 230aii, 230b)

All function instances, primary and secondary may execute their logic on the input (step 4 of FIG. 10). Typically this may involve keeping and updating some internal state that may need to be synchronized between the instances, if for example the logic contains some random decisions. This synchronization will ensure that all instances operate and produce equivalent output. A slow loop block implementation may decide to do state synchronization in-band, that is during the processing itself, and a fast loop block out-of-band, or parallelly to the calculation itself. It will be appreciated that the latter may cause two instances to operate on different states temporarily, and therefore produce different outputs, which may none the less still be acceptable.

If the function has time budget within a single iteration of its loop for full synchronization of states, then one solution is to externalize the state to some database. In this case, before each iteration of the processing logic on a new input data, the state should be fetched from the database, and on each change to the state its representation should be saved back to the database. Implementation parameters including whether the database is distributed or not, or co-location of data and compute, are design details that will be influenced by the available control cycle time budget for a specific application.

### Phase 3: Producing Output and State Synchronization (Method Steps 140, 150, 240a, 240b, 250a, 250b)

When the primary instance finishes producing its output, this output is sent out towards the succeeding blocks (step 7 of FIG. 10). It will be appreciated that only the primary instance is sending output, in order to save succeeding blocks from having to eliminate duplicate input.

In case of a slow loop block, the primary instance also synchronizes the internal state of all instances, to ensure consensus with respect to modeling the physical reality on which they operate.

In some examples, it may be that for a given succeeding block, receiving the same output multiple times does not require additional processing to remove duplicates. For example, a video camera image of a still scenario does not change with time, and therefore it is irrelevant if the same image frame was sent out twice. In such cases even the slow loop implementation may forgo output sanitization, and have all instances to send output, even if they are duplicate. It will be appreciated that the decision as to whether or not to remove duplicate outputs may be taken according to the particular use case under consideration.

### States of Operation

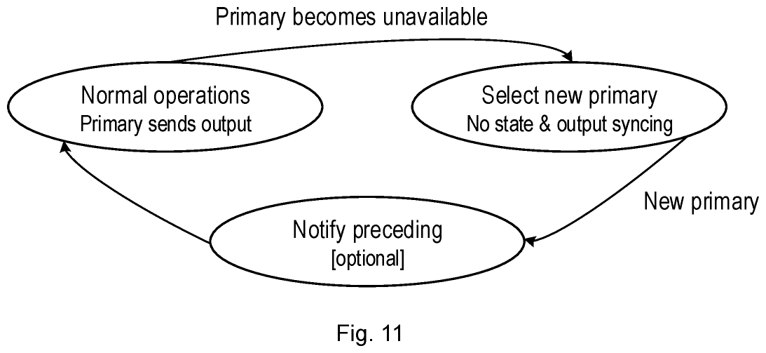

FIG. 11 illustrates different states in which a controller node (function block) can exist, and the transitions between these states.

Normal operations: In this state, phases 1 to 3 discussed above are executed, until the primary instance becomes unavailable, for example owing to software failure. It will be appreciated that the nature of the failure, or how it is detected, is outside the scope of the present disclosure, but typically execution environments will be provided with some active or passive signaling for such detection.

Election: Whenever there is no primary instance agreed on by the instances, then a new primary is selected by the instances. Selection may be implemented via configuration or by consensus mechanisms, but should ensure that at any given moment, there is only at most one primary instance that is recognized by all instances. Primary election may be one of:
Dynamic: the fastest instance of a certain block sends the calculated output to the channel for the following functions. Then some kind of software locking mechanism is applied to block the other instances from sending their output to the channel
Static: there is a configured primary instance; if it will not produce the output within a certain time budget a secondary instance will send the calculated output to the channel. (The order of secondary control instance(s) is also configured)

Notification: When a new primary is selected/assigned, it may in some examples be beneficial for preceding blocks to learn about it directly, for example if they rely on optimized messaging setups for output sending which should be reconfigured. In such cases, the new primary may send a control message over the feedback channel, which in some examples is referred to as the beware signal. If notification is carried out, then after notification is performed, operations return to the normal state. If notification is not appropriate or beneficial, then the controller node may return to the normal operations state immediately after selecting a new primary instance.

### Qualifier

As discussed above, according to example implementations of a controller node, the node may contain a Qualifier, which performs the function of determining autonomously the slow-vs-fast loop regime the block is operating at (for example performing the determination at step 212 of method 200). The determination of slow-vs-fast loop regime may be performed by examining timestamp differences of the output data and corresponding feedback (T_{feedback}), and those of the processing (T_{proc}) and state synchronization (T_{sync}) steps of the block, according to a simple relation:

$${T}_{p r o c} + {T}_{s y n c} < {T}_{feedback}$$

If the relation holds, then it is a slow loop, otherwise it is fast loop. It will be appreciated that if the feedback is so quick that T_{proc}>T_{feedback} then the function cannot fulfill the service at all, which calls for re-design of the application. T_{proc} and T_{sync} may come from direct run-time measurements (allowing for dynamic changing of the regime), or from a configuration that is supplied at start-up or hard-coded into the application.

Once determined, the Qualifier instructs all instances to enact the mode of operation corresponding to the regime.

There are some optional variants of the Qualifier that may or may not be used at a given deployment. In one option, referred to as lazy start, the Qualifier may start out by trying the slow loop regime and only adjust it if the criterion in the Equation above is violated. In a second option, referred to as a Hard-coded Qualifier, the instances may work according to hard-coded regimes, decided either during development or deployment time. This may be appropriate for example for existing brown-field deployments or legacy systems that do not have the functionality of a Qualifier. In a third option, referred to as Warm stand-by check, the Qualifier can also be invoked for determining if the secondary instances of a certain block can work in warm hot-standby mode. If the following scenario can be fulfilled:

$${T}_{p r o c}^{p rimary} + {T}_{fault \_ detection} + {T}_{i n i t}^{secondary} + {T}_{p r o c}^{secondary} < {T}_{feedback}$$

then the secondary instances may be allowed to be warm-hot standby mode, otherwise they should be active in order to fulfill the timing requirements of the loop.

Examples of the present disclosure thus provide methods and nodes operable to implement industrial control application of a physical entity in a resilient manner, ensuring that in the event of failure of a function instance, consistent control information is provided to the physical entity, as a result of the synchronisation of internal states between control function instances. Such synchronisation would be counterproductive for many cloud based control applications, such as web services, but in the case of control of a physical entity, it can ensure safety and performance of the physical entity in the event of failover between control instances.

In some examples, the control can be implemented as a chain of functional steps, in which each step may have a decreased scope of understanding over the whole application than its predecessor, but an increased understanding of physical device details. Each element in the chain comprises a controller node which may execute a logical function that runs in one or more replicas as function instances executing in parallel for reliability and/or increased performance. Each function may receive input over the same input channel from the function preceding it and may send its output to the function following it. An input/output channel may comprise a database, or a message queue (also known as an event queue). It is envisaged that all replicas of the control function have access to the channel, receiving substantially the same information but possibly with some time variance. The output of the function is unique for each unique input, with the control node including some consensus mechanism for deciding which instance's output is actually made available on the output channel, if there are multiple copies available. This mechanism may be the selection of a primary instance.

Examples of the present discourse can prevent failure events in an industrial cloud control application from causing critical inconsistencies in device control, and can be used to provide state synchronization capability for ensuring a more reliable deployment of both monolithic and microservice-style control applications. Examples of the methods and nodes disclosed herein can accommodate a control loop that is either faster or slower than state synchronization between function instances, ensuring flexibility of implementation. The use of multiple instances operating in parallel for the control of a physical entity affords several advantages, including maintaining or improving reliability characteristics of duplicated monolithic controls. If a particular function in a chain of controller nodes needs to be more reliable, the number of replicas function instance sin that particular controller node can be increased, while the number of replicas instances in other controller nodes may remain the same. Similarly, controlled scalability can be introduced per control function in a chain of controller nodes. Considering the example of mobile robots, higher-level trajectory planning happens relatively less frequently compared to low-level motor control, meaning that controller nodes carrying out such higher-level trajectory control can serve many devices with fewer function instances. Different levels of reliability per function can also be set, for example in any failure case, one function in the chain may have at least 3 working instances, while another function may have only a single working instance.

Examples of the present disclosure are fully compatible with existing deployments. Specifically, network features, such as TSN FRER may be considered as a function in the chain, and may be handled in the same way by its preceding and succeeding functions, resulting a coordinated operation of the compute and network domains.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims or numbered embodiments. The word “comprising” does not exclude the presence of elements or steps other than those listed in a claim or embodiment, “a” or “an” does not exclude a plurality, and a single processor or other unit may fulfil the functions of several units recited in the claims or numbered embodiments. Any reference signs in the claims or numbered embodiments shall not be construed so as to limit their scope.

1-31. (canceled)

32. A computer implemented method for controlling a physical entity, wherein the method is performed by a controller node running at least two instances of a logical control function, the method comprising:
receiving, over an input mechanism, node input data relating to the physical entity;
providing, to each of the at least two instances of the control function, instance input data generated from the node input data;
causing at least one of the instances to process the received instance input data and generate instance output data;
providing, over an output mechanism, instance output data from at least one of the instances of the control function, wherein the output mechanism is operably connected to the physical entity; and
synchronizing an internal state of each of the at least two instances of the control function.

33. The method of claim 32, wherein, if a combined instance processing and instance state synchronization time satisfies an operational timing condition, the method comprises synchronizing internal states of the at least two instances of the control function in a process that is synchronized with the providing, over the output mechanism, of instance output data from at least one of the instances of the control function.

34. The method of claim 32, wherein, if a combined instance processing and instance state synchronization time does not satisfy an operational timing condition, the method comprises synchronizing internal states of the at least two instances of the control function in a process that is not synchronized with provision, over the output mechanism, of instance output data from at least one of the instances of the control function.

35. The method of claim 33, wherein synchronizing internal states of the at least two instances of the control function in a process that is synchronized with provision, over the output mechanism, of instance output data from at least one of the instances of the control function comprises synchronizing an internal state of each of the at least two instances of the control function after completion of processing of instance input data by each instance of the control function and before providing, over the output mechanism, instance output data from at least one of the instances of the control function.

36. The method of claim 33, wherein, synchronizing internal states of the at least two instances of the control function in a process that is not synchronized with provision, over the output mechanism, of instance output data from at least one of the instances of the control function comprises:
providing, over the output mechanism, instance output data from at least one of the instances of the control function as soon as such instance output data is generated; and
synchronizing an internal state of each of the at least two instances of the control function after provision of the instance output data.

37. The method of claim 33, further comprising determining whether the combined instance processing and instance state synchronization time satisfies the timing condition, wherein the timing condition is based upon a timing parameter of a control loop of which the control function is a part.

38. The method of claim 32, wherein the at least two instances of the control function comprise a primary instance and at least one secondary instance, and wherein providing, over an output mechanism, instance output data from at least one of the instances of the control function comprises providing instance output data from the primary instance.

39. The method of claim 38, wherein, if a failover time satisfies a failover timing condition, causing at least one of the instances to process the received instance input data and generate instance output data comprises causing only the primary instance to process the received instance input data and generate instance output data.

40. The method of claim 38, wherein, if a failover time does not satisfy a failover timing condition, causing at least one of the instances to process the received instance input data and generate instance output data comprises causing all instances to process the received instance input data and generate instance output data.

41. The method of claim 38, wherein the failover time comprises a time taken for:
processing of instance input data by the primary instance;
detection of a fault at the primary instance;
initiation of a secondary instance; and
processing of instance input data by the initiated secondary instance.

42. The method of claim 38, further comprising determining which of the at least two instances of the control function comprises the primary instance.

43. The method of claim 32, wherein providing, to each of the at least two instances of the control function, instance input data generated from the node input data, comprises:
each of the at least one instances of the control function receiving at least a part of the node input data from the input mechanism if a combined instance processing and instance state synchronization time does not satisfy an operational timing condition; and
one of the instances receiving the node input data and providing instance input data, generated from the node input data, to the remaining instance or instances if the combined instance processing and instance state synchronization time satisfies the operational timing condition.

44. The method of claim 32, wherein the instance input data provided to any one instance of the control function satisfies a functional similarity criterion with respect to the instance input data provided to all other instances of the control function.

45. A computer implemented method for controlling a physical entity in accordance with a control application, wherein the method is performed by a system comprising a plurality of controller nodes, each controller node implementing a logical control function comprised within the control application, the method comprising:
receiving, over an input mechanism and at an input controller node of the system, system input data relating to the physical entity;
causing the system input data to be sequentially processed by the logical control functions of individual controller nodes in the system to generate system output data; and
providing the system output data over an output mechanism, wherein the output mechanism is operably connected to the physical entity.

46. The method of claim 45, wherein causing the system input data to be sequentially processed by the logical control functions of individual controller nodes in the system to generate system output data comprises:
for controller nodes other than the input controller node:
receiving, over an input mechanism and from a preceding controller node in the system, node input data relating to the physical entity;
processing the node input data according to the logical control function of the controller node, and generating node output data; and
providing the node output data to an output mechanism that is operably connected to the physical entity; and
wherein the output mechanism is connected to at least one of a succeeding controller node or to at least one actuator operable to carry out the control determined by the controller node on the physical entity.

47. The method of claim 45, wherein each node in the system is operable to:
receive node input data from a plurality of other controller nodes in the system;
provide node output data to a plurality of other controller nodes in the system; and
wherein each controller node in the system is operable to receive node input data from the physical entity.

48. The method of claim 45, wherein each controller node is operable to process data a different level of abstraction from an application domain of the control application.

49. The method of claim 48, wherein the controller nodes of the system comprise a chain from the input controller node to an output controller node, wherein the input controller node is operable to process data from an application domain of the control application, and wherein each controller node in the chain is operable to process data at an increasing level of abstraction from the application domain, and wherein the output controller node is operable to provide output data in the physical domain of the physical entity.

50. A controller node for controlling a physical entity, wherein the controller node is operable to run at least two instances of a logical control function, the controller node comprising processing circuitry configured to cause the controller node to:
receive, over an input mechanism, node input data relating to the physical entity;
provide, to each of the at least two instances of the control function, instance input data generated from the node input data;
cause at least one of the instances to process the received instance input data and generate instance output data; and
provide, over an output mechanism, instance output data from at least one of the instances of the control function, wherein the output mechanism is operably connected to the physical entity;
the processing circuitry being further configured to cause the controller node to synchronize an internal state of each of the at least two instances of the control function.

51. A system for controlling a physical entity in accordance with a control application, the system comprising a plurality of controller nodes, each controller node implementing a logical control function comprised within the control application, the system configured to:
receive, over an input mechanism and at an input controller node of the system, system input data relating to the physical entity;
cause the system input data to be sequentially processed by the logical control functions of individual controller nodes in the system to generate system output data; and
provide the system output data over an output mechanism, wherein the output mechanism is operably connected to the physical entity.
